(19) United States
(12) Patent Application Publication
(10) Pub. No.: US 2008/0091622 A1
(43) Pub. Date: Apr. 17, 2008

(54) Index and Fund Based on Investment Time Horizon

(75) Inventors: Jeffrey Yass, Haverford, PA (US); Sam Chong, Philadelphia, PA (US)

Correspondence Address: FISH & RICHARDSON P.C., P.O. BOX 1022, MINNEAPOLIS, MN, 55440-1022, US

(73) Assignee: WAVES LICENSING, LLC, Wilmington, DE (US)

(21) Appl. No.: 11/550,333

(22) Filed: Oct. 17, 2006

(51) Int. Cl. G06Q 40/00

(52) U.S. Cl. 705/36 R

(57) ABSTRACT

A method of determining membership in an index based on an investment time horizon comprises determining an asset allocation commensurate with the investment time horizon and constituting the index based on the asset allocation determination. The method may further comprise rebalancing the asset allocation, and the investment time horizon may be factored into the rebalancing. An index may be constituted according to the method, and a marketplace may comprise one or more indices.

### TECHNICAL FIELD

This invention relates to financial instruments, and more particularly to determining membership of financial instruments in an index.

### BACKGROUND

As used herein, the term “financial instruments” includes securities, commodities and any other financial instruments created, developed or otherwise derived from an index, including without limitation, exchange traded funds, options (including, but not limited to, options on any index), futures, and swaps.

When planning for retirement or savings, many people choose to invest their money. Generally, the goal is to have the worth of the investment increase over time. To accomplish this goal, many people use retirement investment vehicles such as 401(k) plans, mutual funds, tax-free investments, or the like. Often, the person planning for retirement or savings chooses a mutual fund in which to invest, or after completing a survey, chooses various mutual funds based on risk allocation. For example, a person wishing to retire in 50 years may decide to invest in a mutual fund comprising mostly equity, while a person wishing to retire in 5 years may decide to invest in a mutual fund comprising mostly treasury bills or bonds. In either scenario, the mutual funds have a general amount of risk associated with them during the life of the funds.

Generally, the risk associated with an investment generally remains substantially the same during the life of the investment. This is true whether a person invests in a high risk, or “aggressive,” investment or a low risk, or “conservative,” investment. This means that if a person decides to invest money in a conservative investment for 25 years, they may not obtain the same increase in their investment had he or she invested in an aggressive fund. Further, if the person decided to invest in an aggressive investment for 25 years, the person generally has a higher risk of the principal decreasing by the end of the 25 years as compared to a conservative investment.

### SUMMARY

According to an embodiment of the invention, a method of determining membership in an index based on an investment time horizon comprises determining an asset allocation commensurate with the investment time horizon and constituting the index based on the asset allocation determination.

According to another embodiment, a method of determining membership in an index based on an investment time horizon comprises determining an asset allocation commensurate with the investment time horizon; constituting the index based on the asset allocation determination; and rebalancing the asset allocation of the index. In this embodiment, the investment time horizon is factored into the rebalancing.

According to yet another embodiment, a financial instruments marketplace comprises at least one index, or options on the index, the index comprising a plurality of financial instruments, wherein the plurality of financial instruments are selected by determining an asset allocation commensurate with an investment time horizon, and constituting the index based on the asset allocation determination.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 shows a graphical representation of the time-based allocation set forth in Table 3.

FIG. 2 is a schematic diagram of a computer system.

### DETAILED DESCRIPTION

As used herein, the terms “select” and “determine” include selecting, electing, choosing, determining, establishing, calculating, picking, obtaining, or any other similar action. The term “create” is used for purposes of convenience, not limitation, and includes forming, devising, developing, making, producing or any other similar action. The term “index” also is used for purposes of convenience, not limitation, and includes an index, a fund, and the like.

An index enables an investor to maintain an investment for a predetermined investment time horizon. The “investment time horizon” is the period of time from the date of investing in the index to the investor's actual, planned, intended, or anticipated date of withdrawing the money from the index. The time period may be a number of years, months, days, or other increment of time.

The index may be comprised of financial instruments, including, but not limited to, equities, bonds, exchange traded finds (“ETFs”), exchange traded notes (“ETNs”), fixed income products, commodities, real estate, and currencies. In some embodiments, the index is comprised of at least one of financial instruments, equities, bonds, ETFs, ETNs, fixed income products, commodities, real estate, and currencies.

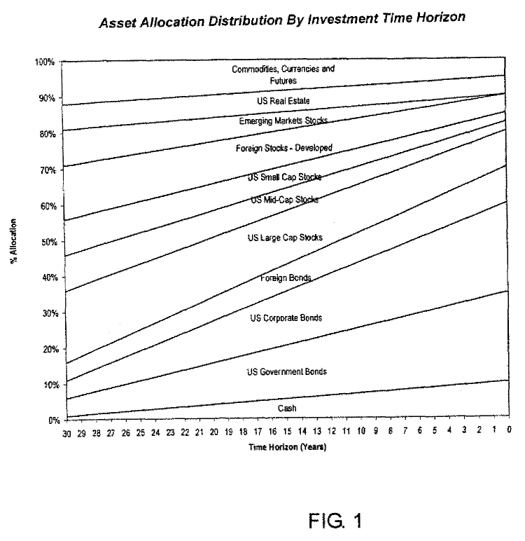

The asset classes for the index may be broad market asset classes that provide investors with diversification. In some embodiments, the index invests in an asset class by (a) investing directly in product(s) that track an index(es) that serve(s) as a proxy(ies) for the asset class(es); (b) investing in ETF(s) and/or ETN(s) that serve(s) as a proxy(ies) for the asset class(es); (c) investing in individual securities, commodities, currencies and other financial instruments that comprise the asset class(es), or (d) a combination, of (a)-(c). Asset classes are known to those skilled in the art. A non-limiting example of asset classes is found in FIG. 1.

TABLE 1

| Asset Class Example | Index Proxy Example | ETF Proxy Example | Individual Securities |
|---|---|---|---|
| Cash | US Treasury 3-Month T-Bills | n/a | US Treasury 3-Month T-Bills |
| US Government Bonds | Lehman Brothers US Treasury Index | Appropriate Bond ETF | Appropriate Bonds |
| US Corporate Bonds | Lehman Brothers US Corporate index | Appropriate Bond ETF | Appropriate Bonds |
| Foreign Bonds | Lehman Brothers Pan-European Universal | Appropriate Bond ETF | Appropriate Bonds |
| | Index | | |
| | Lehman Brothers Asian-Pacific Asian Index | Appropriate Bond ETF | Appropriate Bonds |
| US Large Cap Stocks | S&P 500 Index | Appropriate Equity ETF | Appropriate Stocks |
| US Mid-Cap Stocks | Russell Midcap Index | Appropriate Equity ETF | Appropriate Stocks |
| US Small Cap Stocks | Russell 2000 Index | Appropriate Equity ETF | Appropriate Stocks |
| Foreign Stocks - Developed | MSCI EAFE Index | Appropriate Equity ETF | Appropriate Stocks |
| Emerging Markets Stocks | MSCI BRIC Index | Appropriate Equity ETF | Appropriate Stocks |
| US Real Estate | FTSE NAREIT All REITs Index | Appropriate Equity ETF | Appropriate Stocks |
| Commodities, Currencies and | Dow Jones-AIG Commodity Index | Appropriate ETF/ETN | Appropriate Contracts/Positions |
| Futures | | | |

In some embodiments, the index provides investors a diversified portfolio of investments. The asset allocation for the index is commensurate with an investor's investment time horizon. In some embodiments, when a longer investment time horizon is used, the index comprises “aggressive investments” during a portion of the investment time horizon. “Aggressive investments” are understood to be those investments that are likely to be volatile or highly volatile, i.e., investments likely to have a rapid gain or loss associated therewith. In other embodiments, when a shorter investment time horizon is used, the index comprises “conservative investments.” “Conservative investments” are understood to be those investments that are less likely to experience a rapid gain or loss. A conservative investment generally is a less risky investment than an aggressive investment because it is generally less likely to result in a decrease in principal.

In some embodiments, during the initial, or early, years of the investment, the risk allocated to the fund or index is relatively higher compared to the risk allocated to the fund or index during the later years, i.e., the years closer to the end of the investment time horizon. As a non-limiting example, if the investment time horizon is thirty years, then the risk allocated to the fund or index is relatively higher during the first year and relatively lower during the last year.

In some embodiments, the index is rebalanced on a periodic basis, including, but not limited to, yearly, quarterly, monthly, weekly, daily, biannually, or semiannually. “Rebalancing” means to add or delete financial instruments from the index or to increase the amounts of such financial instruments relative to the amount of other financial instruments within the index based on predetermined criteria. Rebalancing may take place automatically. In some embodiments, the rebalancing may be based on a predetermined rebalancing allocation schedule. In some embodiments, the investment time horizon is factored into the rebalancing. As a non-limiting example, if, based on the investment time horizon, the index initially comprises aggressive investments, by the completion of the investment time horizon, the index comprises conservative investments.

A rebalancing mechanism is used when rebalancing the index. In some embodiments, the rebalancing mechanism follows straight-line appreciation and depreciation that converges to a predetermined asset allocation at investment time horizon 0:

Appreciation (Depreciation)=(Allocationₜ₋ₙ−Allocationₜ)/n

where:
Allocation is the percentage of assets allocated to a particular asset class
t is a point along the investment time horizon
n is an amount of time along the investment time horizon less than or equal to t.

### Using this formula, if the rebalancing is to occur annually, then

Annual Appreciation (Depreciation)=(Allocationₜ₋ₙ−Allocationₜ)/n

where:
Allocation is the percentage of assets allocated to a particular asset class
t is a point along the investment time horizon
n is a number of years along the investment time horizon less than or equal to t.
   As a non-limiting example, the allocation to an asset class may be 20% for an index with an investment time horizon of 30 years. At year 0, the targeted allocation for this asset class may be 10%. In order to go from 20% to 10% evenly over the 30-year investment time horizon, the allocation to this asset class decreases 0.3333% per year for the 30-year period. In some embodiments, if the investor decides to continue the investment in the index after the investment time horizon is reached, the allocation would rebalance in accordance with the year 0 allocation(s) each time the index is subsequently rebalanced. In other embodiments, after the investment time horizon is reached, an investment advisor specifies a new investment time horizon if any investment is to remain in the index and this new investment time horizon is taken into account during subsequent rebalancing. In still yet other embodiments, the investor discontinues the investment in the index after the investment time horizon is reached and purchases a new investment that corresponds to a new investment time horizon.

Alternatively, instead of using straight-line appreciation and depreciation to rebalance the index, other rebalancing mechanisms may be used. As non-limiting examples, rebalancing mechanisms based on mathematical formulas, equations, functions, etc. may also be applied. In other instances, rebalancing mechanisms based on a professional assessment which takes into account the return of the investment to date and the desired return of the investment over the investment time horizon may also be applied.

The index described herein may be classified based on investment time horizons. As a non-limiting example, an index with an investment time horizon of 30 years, which is rebalanced annually, may tend to hold asset classes that possess higher levels of volatility than a fund with an investment time horizon of 5 years. This is shown in Table 2. If the straight-line rule based rebalancing mechanism set forth above is used for this example, annual adjustments for each respective asset class allocation based on asset allocations at investment time horizon year 30 and year 0 are shown in Table 3. FIG. 1 shows a graphical representation of the time-based allocation set forth in Table 3.

In some embodiments, the index guarantees an interest rate. The guaranteed interest rate may be equal to the rate of increase or decrease of the various financial instruments which comprise the index. In other embodiments, the guaranteed interest rate may be a rate determined by a party overseeing the index. The interest rate may be guaranteed by constantly trading financial instruments in an attempt to maintain or substantially maintain the interest rate.

In some embodiments, one or more funds, indices, securities, futures or other financial instruments based on investment time horizon may be traded on a marketplace for such financial instruments. It is understood that the term “marketplace” is construed broadly herein to include (i) all U.S. and foreign exchanges, including without limitation, all organizations, associations or groups of persons, whether incorporated or unincorporated, that constitute, maintain or provide a marketplace or facilities for bringing together buyers and sellers of securities, futures and/or other financial instruments, for bringing together orders for securities, futures and/or other financial instruments of multiple buyers and sellers, or for otherwise performing with respect to securities, futures and/or other financial instruments the functions commonly performed by a stock exchange, commodity exchange, trading center, alternative trading system, trade reporting system, alternative display facility, automated trading center, electronic communications network or other similar facility as those terms are respectively generally understood; (ii) all U.S. and foreign quotation and trade reporting systems or any other similar facilities or market centers where orders to buy and sell securities, futures, and/or other financial instruments interact with each other; (iii) all, and all market facilities maintained by any such, exchanges, quotation systems, trading centers, alternative trading systems, alternative display facilities, automated trading centers, electronic communications networks or other facilities; and (iv) all U.S. and foreign over-the-counter markets, including, without limitation, all in-person, telephone, computer or other electronic networks that connect buyers and sellers of securities, futures and/or other financial instruments. A marketplace may constitute an exchange, quotation system, trading center, automatic trading system, electronic communications network or other marketplace on which one or more funds, indices, securities, futures or other financial instruments according to the invention are traded.

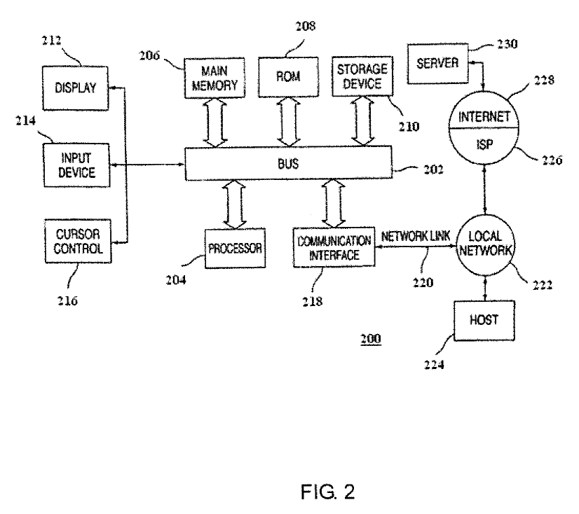

FIG. 2 illustrates an exemplary system, such as a computer system, on which the methodology described herein can be utilized. One suitable computer system upon which the method may be implemented is shown at 200. Computer system 200 includes a bus 202 or other communication mechanism for communicating information, and a processor 204 coupled with bus 202 for processing information. Computer system 200 also includes a main memory 206, such as a random access memory (RAM) or other dynamic storage device, coupled to buts 202 for storing information and instructions to be executed by processor 204. Main memory 206 also may be used for storing temporary variable or other intermediate information during execution of instructions to be executed by processor 204. Computer system 200 further includes a read only memory (ROM) 208 or other static storage device coupled to bus 202 for storing static information and instructions for processor 204. A storage device 210, such as a magnetic disk or optical disk, is provided and coupled to bus 202 for storing information and instructions.

Computer system 200 may be coupled via bus 202 to a display 212, such as a cathode ray tube (CRT), for displaying information to a computer user. An input device 214, which may include alphanumeric and other keys, is coupled to bus 202 for communicating information and command selections to processor 204. Another type of user input device is cursor control 216, such as a mouse, a trackball, or cursor direction keys for communicating direction information and command selections to processor 204 and for controlling cursor movement on display 212. This input device typically has two degrees of freedom in two axes, a first axis (e.g., x) and a second axis (e.g., y), that allows the device to specify positions in a plane.

According to one embodiment, computer system 200 operates in response to processor 204 executing one or more sequences of one or more instructions contained in main memory 206. Such instructions may be read into remain memory 206 from another computer-readable medium, such as storage device 210. Execution of the sequences of instructions contained in main memory 206 causes processor 204 to perform the process steps described herein. One or more processors in a multi-processing arrangement may also be employed to execute the sequences of instructions contained in main memory 206. In alternative embodiments, hard-wired circuitry may be used in place of or in combination with software instructions to implement the methodology. Thus, practicing the methodology are not limited to any specific combination of hardware circuitry and software, and the description here and below is understood to be an exemplary embodiment of a system of the invention.

A software application containing coding for implementing the process described herein can be stored or reside in any suitable computer-readable medium. The term “computer-readable medium” as used herein refers to any medium that participates in providing instructions to processor 204 for execution. Such a medium may take many forms, including, but not limited to, non-volatile media, volatile media, and transmission media. Non-volatile media include, for example, optical or magnetic disks, such as storage device 210. Volatile media include dynamic memory, such as main memory 206. Transmission media include coaxial cables, copper wire, and fiber optics, including the wires that comprise bus 202. Transmission media can also take the form of acoustic or light waves, such as those generated during radio frequency (RF) and infrared (IR) data communications. Common forms of computer-readable media include, for example, floppy disk, a flexible disk, hard disk, magnetic tape, and other magnetic medium, a CD-ROM, DVD, any other optical medium, punch cards, paper tape, any other physical medium with patterns of holes, a RAM, a PROM, an EPROM, a FLASHEPROM, any other memory chip or cartridge, a carrier wave as described hereinafter, or any other medium from which a computer can read.

Various forms of computer-readable media may be involved in carrying one or more sequences of one or more instructions to processor 204 for execution. For example, the instructions may initially be home on a magnetic disk of a remote computer. The remote computer car load the instructions into its dynamic memory and send the instructions over a telephone line using a modem. A modem local to computer system 200 can receive the data on the telephone line and use an infrared transmitter to convert the data to an infrared signal. An infrared detector coupled to bus 202 can receive the data carried in the infrared signal and place the data on bus 202. Bus 202 carries the data to main memory 206, from which processor 204 retrieves and executes the instructions. The instructions received by main memory 206 may optionally be stored on storage device 210 either before or after execution by processor 204.

Computer system 200 also includes a communication interface 218 coupled to bus 202. Communication interface 218 provides a two-way data communication coupling to a network link 220 that is connected to a local network 222. For example, communication interface 218 may be an integrated services digital network (ISDN) card or a modern to provide a data communication connection to a corresponding type of telephone line. As another example, communication interface 218 may be a local area network (LAN) card to provide a data communication connection to a compatible LAN. Wireless links may also be implemented. In any such implementation, communication interface 218 sends and receives electrical, electromagnetic, or optical signals that carry digital data streams representing various type of information.

Network link 220 typically provides data communication through one or more networks to other data devices. For example, network link 220 may provide a connection trough local network 222 to a host computer 224 or to data equipment operated by an Internet Service Provider (ISP) 226. ISP 226 in turn provides data communication services through the worldwide packet data communication network, now commonly referred to as the “Internet” 228. Local network 222 and Internet 228 both use electrical, electromagnetic, or optical signals that carry digital data streams. The signals through the various networks and the signals on network line 220 and through communication interface 218, which carry the digital data to and from computer system 200, are exemplary forms of carrier waves transporting the information.

Computer system 200 can send messages and receive data, including program codes, through the network(s), network line 220, and communication interface 218. In the Internet example, a server 230 might transmit a requested code for an application program through Internet 228, ISP 226, local network 222, and communication interface 218.

The received code may be executed by processor 304 as it is received, and/or stored in storage device 310, or other non-volatile storage for later execution. In this manner, computer system 300 may obtain an application code in the form of a carrier wave.

A number of embodiments of the invention have been described. Nevertheless, it will be understood that various modifications may be made without departing from the spirit and scope of the invention. For example, although an example refers to stocks and companies, the methods described herein can be used for any type of financial instrument. Accordingly, other embodiments are within the scope of the following claims.

What is claimed is:

1. A method of determining membership in an index based on an investment time horizon comprising:
determining an asset allocation commensurate with the investment time horizon;
constituting the index based on the asset allocation determination.

2. The method of claim 1, further comprising rebalancing the asset allocation of the index.

3. The method of claim 2, wherein the rebalancing occurs on a periodic basis.

4. The method of claim 2, wherein the investment time horizon is factored into the rebalancing.

5. The method of claim 2, wherein the rebalancing follows straight-line appreciation and depreciation that converges to a predetermined asset allocation at investment time horizon 0.

6. The method of claim 2, wherein the rebalancing of the asset allocation uses the formula
Appreciation (Depreciation)=(Allocationₜ₋ₙ−Allocationₜ)/n
where:
Allocation is a percentage of assets allocated to a particular asset class;
t is a point along the investment time horizon; and
n is an amount of time along the investment time horizon less than or equal to t.

7. The method of claim 2, wherein the rebalancing of the asset allocation uses the formula
Appreciation (Depreciation)=(Allocationₜ₋ₙ−Allocationₜ)/n
where:
Allocation is a percentage of assets allocated to a particular asset class;
t is a point along the investment time horizon; and
n is a number of years along the investment time horizon less than or equal to t.

8. The method of claim 2, wherein the periodic basis comprises at least one of yearly, quarterly, monthly, weekly, daily, biannually, and semiannually.

9. The method of claim 1, wherein the investment time horizon comprises at least one year.

10. The method of claim 1, wherein constituting the index comprises at least one of investing in at least one product that tracks an index that serves as a proxy for an asset class;
investing in at least one exchange traded find that serves as a proxy for an asset class;
investing in at least one exchange traded note that serves as a proxy for an asset class;
investing in at least one individual security that serves as a proxy for an asset class;
investing in at least one commodity that serves as a proxy for an asset class; and
investing in at least one currency that serves as a proxy for an asset class.

11. A method of determining membership in an index based on an investment time horizon comprising:
determining an asset allocation commensurate with the investment time horizon;
constituting the index based on the asset allocation determination;
rebalancing the asset allocation of the index, wherein the investment time horizon is factored into the rebalancing.

12. The method of claim 11, wherein the rebalancing occurs on a periodic basis.

13. The method of claim 11, wherein the rebalancing follows straight-line appreciation and depreciation that converges to a predetermined asset allocation at investment time horizon 0.

14. The method of claim 11, wherein the rebalancing of the asset allocation uses the formula
Appreciation (Depreciation)=(Allocationₜ₋ₙ−Allocationₜ)/n
where:
Allocation is a percentage of assets allocated to a particular asset class;
t is a point along the investment time horizon; and
n is an amount of time along the investment time horizon less than or equal to t.

15. The method of claim 11, wherein the rebalancing of the asset allocation uses the formula
Appreciation (Depreciation)=(Allocationₜ₋ₙ−Allocationₜ)/n
where:
Allocation is a percentage of assets allocated to a particular asset class;
t is a point along the investment time horizon; and
n is a number of years along the investment time horizon less than or equal to t.

16. The method of claim 12, wherein the periodic basis comprises at least one of yearly, quarterly, monthly, weekly, daily, biannually, or semiannually.

17. The method of claim 11, wherein the investment time horizon comprises at least one year.

18. An index comprising a plurality of financial instruments, wherein the plurality of financial instruments are selected by:
determining an asset allocation commensurate with an investment time horizon; and
constituting the index based on the asset allocation determination.

19. The index of claim 18, wherein the asset allocation is rebalanced on a periodic basis, and the investment time horizon is a factor when the asset allocation is rebalanced.

20. The index of claim 19, wherein the periodic basis comprises at least one of yearly, quarterly, monthly, weekly, daily, biannually, and semiannually.

21. The index of claim 18, wherein the plurality of financial instruments are further selected by at least one of investing in at least one product that tracks an index that serves as a proxy for an asset class;
investing in at least one exchange traded fund that serves as a proxy for an asset class;
investing in at least one exchange traded note that serves as a proxy for an asset class;
investing in at least one individual security that serves as a proxy for an asset class;
investing in at least one commodity that serves as a proxy for an asset class, and
investing in at least one currency that serves as a proxy for an asset class.

22. The index of claim 18, wherein the investment time horizon comprises at least one year.

23. A financial instruments marketplace comprising at least one index, or options on the index, the index comprising a plurality of financial instruments, wherein the plurality of financial instruments are selected by:
determining an asset allocation commensurate with an investment time horizon; and
constituting the index based on the asset allocation determination.

24. The financial instruments marketplace of claim 23, wherein the asset allocation is rebalanced on a periodic basis, and the investment time horizon is a factor when the asset allocation is rebalanced.

25. The financial instruments marketplace of claim 23, wherein the periodic basis comprises at least one of yearly, quarterly, monthly, weekly, daily, biannually, and semiannually.

26. The financial instruments marketplace of claim 23, wherein the plurality of financial instruments are further selected by at least one of
investing in at least one product that tracks an index that serves as a proxy for an asset class;
investing in at least one exchange traded fund that serves as a proxy for an asset class;
investing in at least one exchange traded note that serves as a proxy for an asset class;
investing in at least one individual security that serves as a proxy for an asset class;
investing in at least one commodity that serves as a proxy for an asset class; and
investing in at least one currency that serves as a proxy for an asset class.

27. The financial instruments marketplace of claim 23, wherein the investment time horizon comprises at least one year.
